(19) United States
(12) Patent Application Publication
(10) Pub. No.: US 2008/0127578 A1
(43) Pub. Date: Jun. 5, 2008

(54) Saddle Platform

(76) Inventor: Bernhard Dowe, Friedberg (DE)

Correspondence Address: PAUL AND PAUL, 2000 MARKET STREET, SUITE 2900, PHILADELPHIA, PA, 19103, US

(21) Appl. No.: 11/814,534

(22) PCT Filed: Jan. 25, 2006
(86) PCT No.: PCT/EP06/50449

§ 371 Date: Oct. 10, 2007

(30) Foreign Application Priority Data
Jan. 25, 2005 (DE) 10 2005 003 514.0

(51) Int. Cl. B64F 5/00

(52) U.S. Cl. 52/64

(57) ABSTRACT

To avoid complex, expensive scaffolding for maintaining the upper face of an aircraft fuselage, the object of the present invention is to provide a working level for an aircraft that can be simply and rapidly assembled. This is achieved by the following features: a working level; a supporting structure; and at least one bearing surface, which is configured as a strap, the strap extending in substantially the circumferential direction of the fuselage along a substantially circular or elliptical fuselage cross-section.

The present invention relates to a saddle platform for aircraft.

The fuselages of modern aircraft are made with a framework construction, frames or stringers extending along the fuselage cross-section and predefining the outer form of the fuselage. The stringers are arranged at regular or irregular spacings along the length of the fuselage of the aircraft, as a function of the model and design. The gaps between the frames are filled by modern aluminum structures, usually with honeycomb geometry, and are eternally delimited by aluminum or plastics material panels. This lightweight design allows the construction of large fuselages with a comparatively low weight. A low point loading capacity of the individual fuselage sections between the frames is accepted in this case. Point loadings of this kind do not usually occur during normal flying operations. Even during maintenance it has not previously been necessary to load the fuselage since the maintenance work can be carried out from the ground or from scaffolding placed on the ground.

If maintenance work is required on the outer hull of the aircraft then according to prior art scaffolding that is supported on the ground is erected for the aircraft, similar to in the case of building renovation work. The comparatively high costs associated therewith and the long erection period of such a scaffold borne on the ground can be accepted since repair and maintenance work to the fuselage, in particular the upper face, occurs at only irregular and comparatively long intervals.

In the meantime aircraft have been equipped with increasingly more complex antennae on the fuselage upper face. Antennae that have been known for a long time are used to provide satellite phone connections for the passengers on board the aircraft.

Recently however antenna systems for communicating with satellites to provide broadband internet connections have also become available and these are installed on the fuselage. These receiving antennae require active tracking of the parabolic antenna mirror to also ensure an optimum connection between satellite and aircraft during the flight. The cardanically suspended antenna mirrors therefore require complex mechanisms for active tracking. These have to be maintained at regular intervals and this relatively often leads to large long-haul aircraft in particular, which have the corresponding technology, having to have scaffolding erected as far as over the upper face of their fuselage. These scaffolds can be more than 10 m high and are correspondingly complicated and expensive.

With respect to the scaffolds known from the prior art for maintaining the upper face of the fuselage, the object underlying the present invention is therefore to provide a working level for maintenance personnel, which working level can be assembled quickly and easily.

This object is achieved according to the invention in that a saddle platform is provided, comprising a working level, a supporting structure and at least one bearing surface which is formed by at least one strap, the strap substantially extending in the circumferential direction of the fuselage and perpendicular to the longitudinal axis thereof.

The saddle platform according to the invention is placed directly onto the fuselage of the aircraft with the aid of a crane. Punctiform loading of the outer faces of the aircraft hull is avoided in this ease by the strap-like configuration of the bearing surface. According to the present invention a strap is taken to mean a substantially strip-like, flat structure which adapts to the outer surface of the fuselage or is shaped to fit. The saddle platform according to the invention [is], in contrast to a scaffold standing on the ground, not affected by relative movements of the aircraft with respect to the ground.

In general, according to the present invention a strap is taken to mean a bearing element which when placed on the fuselage adapts its shape slightly to the fuselage but is only slightly stretched, or is virtually not stretched at all, in the process.

The platform according to the invention constitutes a conscious breakthrough of the underlying principle that, basically, no elements are allowed to be placed on the outer skin of an aircraft. Only the flat, well-distributed dispersal of forces makes it possible to break through this principle.

It is expedient in this connection if the strap has a larger dimension in the circumferential direction of the fuselage than in the longitudinal direction.

A strap of this kind can be made for example from a sheet metal, preferably aluminum sheet metal.

In a particularly preferred alternative embodiment the strap is made from a textile material, similar to a tensioning strap for heavy loads. Such a material exhibits high tear strength and load-bearing capacity despite the necessary flexibility.

In a preferred embodiment of the invention a plurality of straps, preferably at least 2, 4, 6 or 8, are arranged so as to extend in the circumferential direction and side by side at a spacing from each other in the axial direction of the fuselage. The load of the saddle platform is thus optimally uniformly dispersed over the surface of the fuselage, it still being possible to leave adequate space free between the straps in order to reach the surface of the fuselage or the antenna structures installed thereon.

An embodiment of the invention in which the straps are spaced apart from each other is particularly preferred, the spacing corresponding to the spacing of the frames of the fuselage. The spacing of the straps can alternatively be an integral multiple of the spacing between the frames if this spacing is uniform. The spacing of the straps is taken to mean the spacing between the points of the half width of the respective straps. The saddle platform can thus be placed onto the aircraft in such a way that all straps come to rest on one frame each. Much higher loads can be dispersed across the outer skin of the aircraft in the region of the frames than in the gaps.

It is expedient in this connection if the strap has a width of 100 mm to 500 mm, but preferably a width of 400 mm. With a fixed spacing between two straps arranged side by side it is thus possible to place the saddle platform on aircraft with different frame spacing in such a way that, owing to its width, the strap also always comes to rest on one frame. With appropriate choice of strap width and strap spacing the straps themselves are then located over one frame respectively if the spacings of these frames vary over the length of the fuselages as is the case with some aircraft designs.

An embodiment of the invention is in particular preferred from some applications in which the positions of the individual straps can be adjusted to the saddle platform in the axial direction of the fuselage. i.e. transversely to the lengthwise extent of the straps. This in particular allows adjustment of the strap position to the frame spacing of a fuselage.

Otherwise an embodiment of the invention is preferred in which the straps are spaced apart from each other by 530 mm or between 508 (20 inches) and 530 mm. The spacing of 530 mm matches the frame spacing of an Airbus A 340 while the frame spacing in a Boeing 747 is regularly 20 inches, but can also differ therefrom in some regions. By cleverly choosing the strap widths and spacings it is possible to use one and the same platform in the same manner for a plurality of aircraft or fuselage types, the straps always being located over frames without the strap spacings having to be changed for this purpose.

Since most antennae are arranged at the apex of the upper face of the fuselage an embodiment of the invention is preferred in which a plurality of preferably 2, 4, 6 or 8, straps are arranged one behind the other in the circumferential direction of the aircraft, so they effectively form a strap that is continuous in the circumferential direction. There are thus strap-free regions between the individual straps even in the circumferential direction, into which regions the aircraft antennae or antenna covers can extend without loading by the straps. An embodiment of the invention is preferred in which the length of the strap in the circumferential direction is at least 200 mm, preferably at least 500 mm.

It is particularly expedient if the strap extends over approximately one quarter, preferably over approximately one half of the circumference of the fuselage.

An embodiment of the invention is preferred in which the strap has a layer of padding, preferably consisting of foamed material, microcellular rubber or air. Damage to the outer skin of the aircraft by the action of the strap is thus prevented.

An embodiment of the invention is particularly preferred in which the geometry of the strap and/or the geometry of the supporting structure can be adjusted for various aircraft widths or fuselage diameters. The saddle platform can thus be used for various aircraft designs (narrow body, wide body), for example Airbus A 320, Boeing 737 or Airbus A 340 or Boeing 747.

Owing to the friction between the strap and the fuselage it is hard for the platform to slip against the fuselage. However, to attain optimally high stability of the platform on the fuselage, moreover, it is expedient if the saddle platform has a mechanism to secure against slipping. A mechanism of this kind is in particular a strap, which in the manner of a saddle girth reaches around the fuselage or through it, for example through door openings.

Alternatively or additionally the securing mechanism can be connected to the fuselage, an opening in the fuselage or a part fastened thereto. A support or a stop limit against the supporting surface is also possible. Moreover, in certain embodiments a stay against the ground or against weights resting on the ground can be advantageous. Securing straps of which, where possible, the length can be adjusted and/or tensioned are preferably hooked into door openings in the fuselage and connected to the saddle platform. Profiled sections adapted to the door mounts are used for hooking-in.

An embodiment of the present invention is particularly preferred in which the working level comprises a plurality of elements. This allows a high degree of flexibility for use of the platform on the upper surface of an aircraft. It is particularly expedient if individual elements are removable, their height can be changed or if they can be displaced toward the other elements.

An embodiment is preferred in which the individual elements of the working level extend as far as the fuselage. The maintenance personnel, standing on the working level, can thus reach the antennae or the coverings thereof directly without having to step onto the fuselage.

At their edges the elements of the working level expediently comprise preferably resilient sealing elements which allow flush finishing with the fuselage. A working level configured in this way prevents tools or material from falling through the gap between the working level and the aircraft. This prevents the outer surface of the aircraft from being scratched and ensures the requisite occupational safety for personnel walking on the ground.

In a particularly preferred embodiment of the invention the saddle platform comprises devices, preferably rollers or chains, with the aid of which the platform can be displaced towards the fuselage in the longitudinal direction.

An embodiment of the invention is particularly preferred in which the strap is divided in two and the ends of each of the parts are connected to two pivotally fastened supports. Each of the strap parts extends from an outer edge on the fuselage to approximately the apex of the fuselage, so the apex region itself remains free. The supports are part of the supporting structure or form a connection between the strap and the supporting structure.

It is particularly advantageous in this case if the supports are mounted so as to pivot preferably about the same pivot point or two pivot points that are close to each other. This achieves self-centering of the saddle platform when placed on the fuselage. It is expedient if the two supports are moreover pre-tensioned against each other or against the support structure by springs in such a way that the strap is tensioned even if the platform is not placed on a fuselage.

An embodiment of the saddle platform according to the invention is preferred in which the projections of the supports in a horizontal plane are of equal length. This achieves optimum force distribution along the strap and avoids punctiform introduction of force across the supports.

In a particularly preferred embodiment of the invention the support is connected to the strap by at least one pressure distribution panel that is preferably fastened so as to be articulated. The pressure distribution panels are connected to the supports that are pivotally fastened to the supporting structure at a hinge point between support and distributor panel.

An embodiment of the invention in which the saddle platform can be dismantled is expedient. An embodiment of this kind that can be dismantled is particularly expedient if after assembly, its individual elements can be secured relative to each other by quick release pins. The working platform may thus be compactly stored and advantageously transported, preferably by air freight, to different international sites.

Further features, benefits and uses of the present invention emerge from the following description of a preferred embodiment and the associated figures, in which:

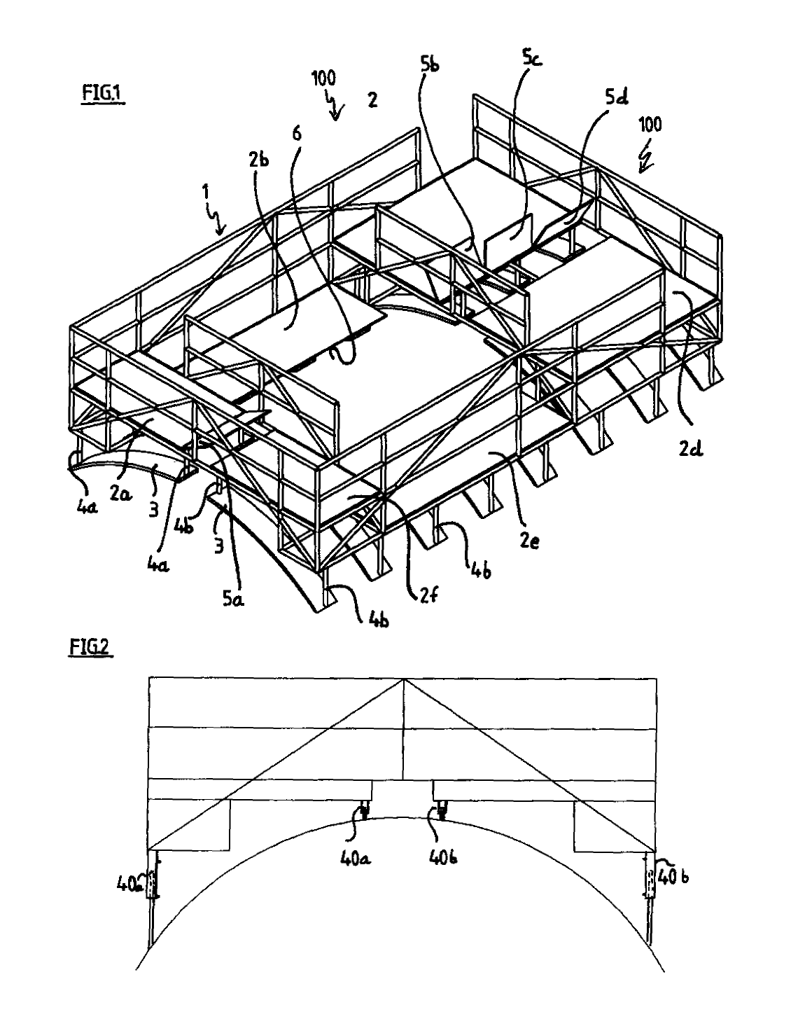

FIG. 1 shows a schematic, three-dimensional view of the saddle platform according to the invention,

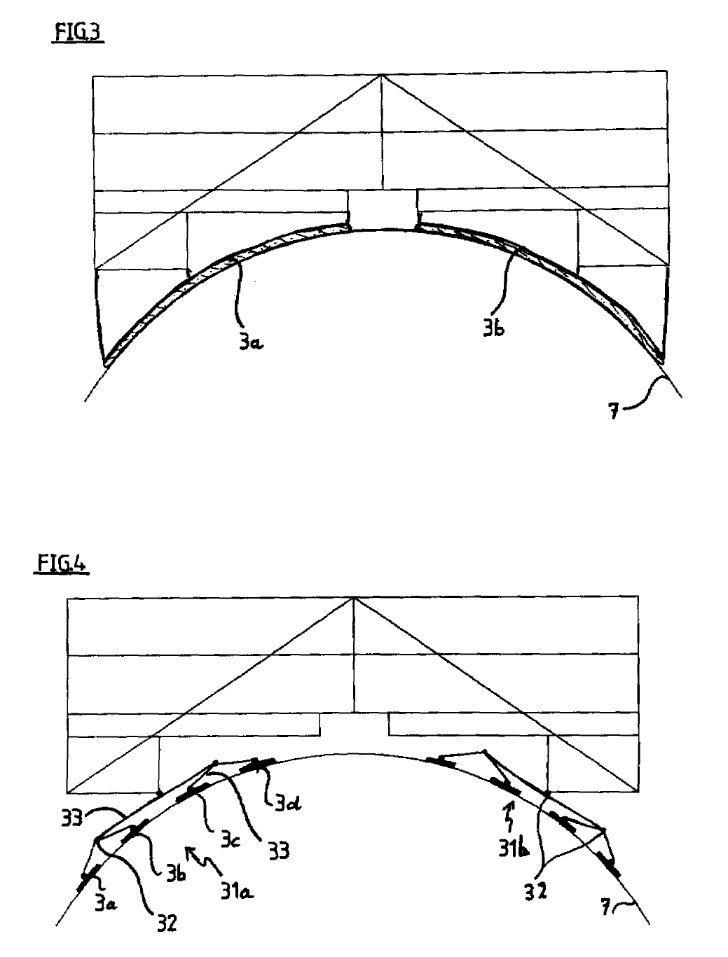

FIG. 2 shows an embodiment of the invention with hydraulically adjustable supports,

FIG. 3 shows an air cushion mounting of the saddle platform according to the invention,

FIG. 4 shows an alternative embodiment of the straps.

FIG. 5 shows an embodiment of the saddle platform with textile strap,

FIG. 6 schematically shows the construction of the textile strap from FIG. 5,

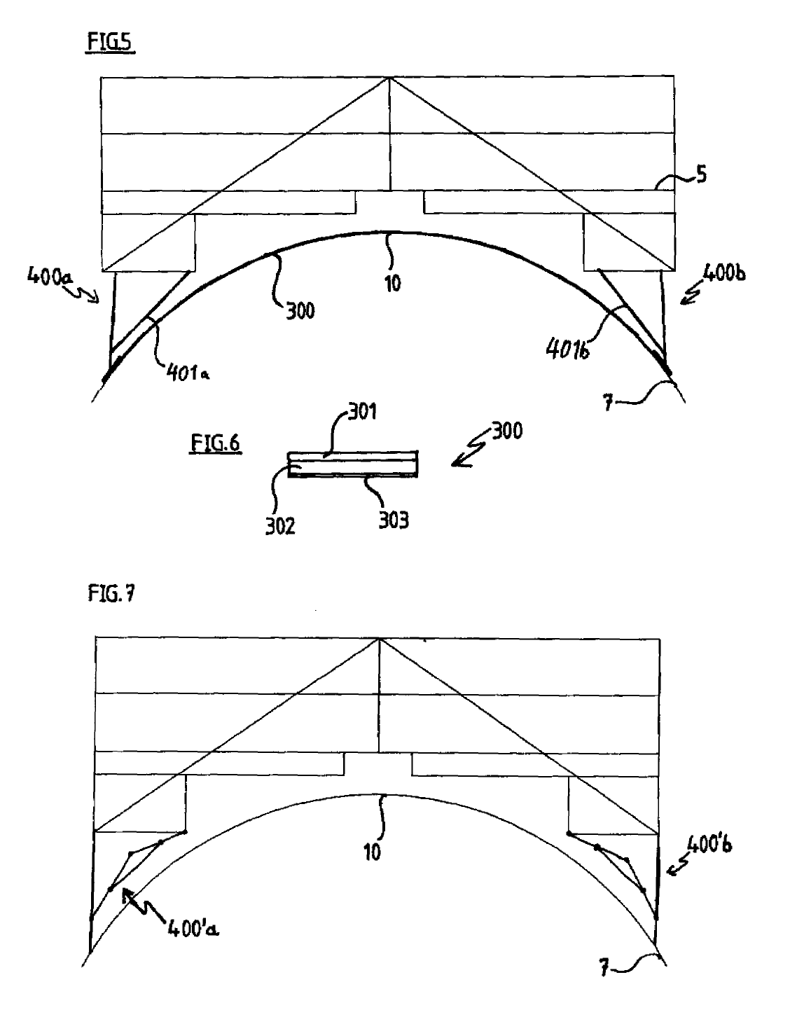

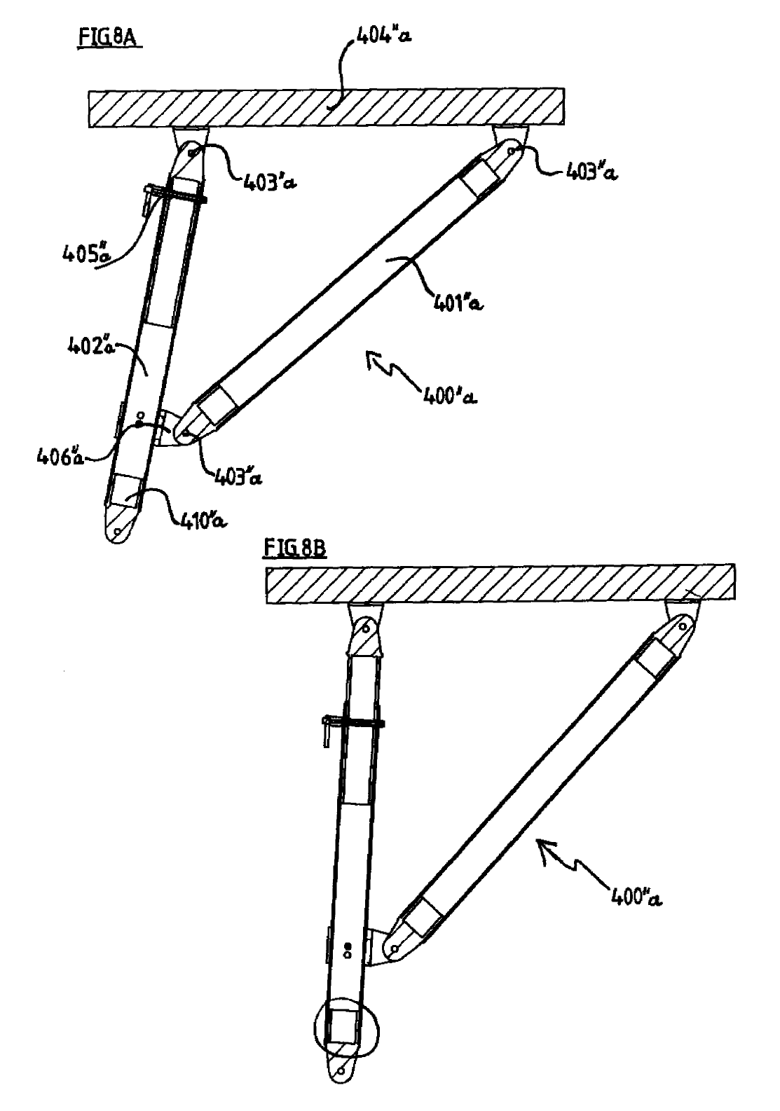

FIG. 7 shows an alternative embodiment of the supports,

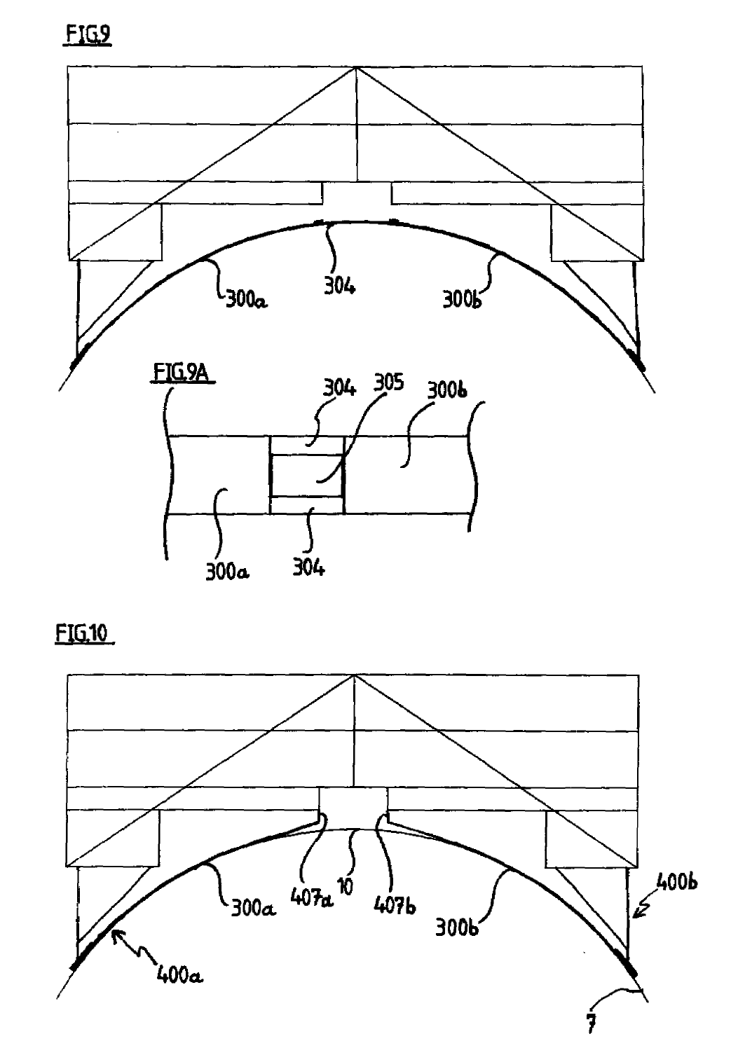

FIGS. 8A and 8B show detailed views of alternative embodiment of a height-adjustable support,

FIG. 9 shows a first embodiment of the strap according to the invention in which the apex of the fuselage remains free,

FIG. 9A shows a plan view of the straps from FIG. 9,

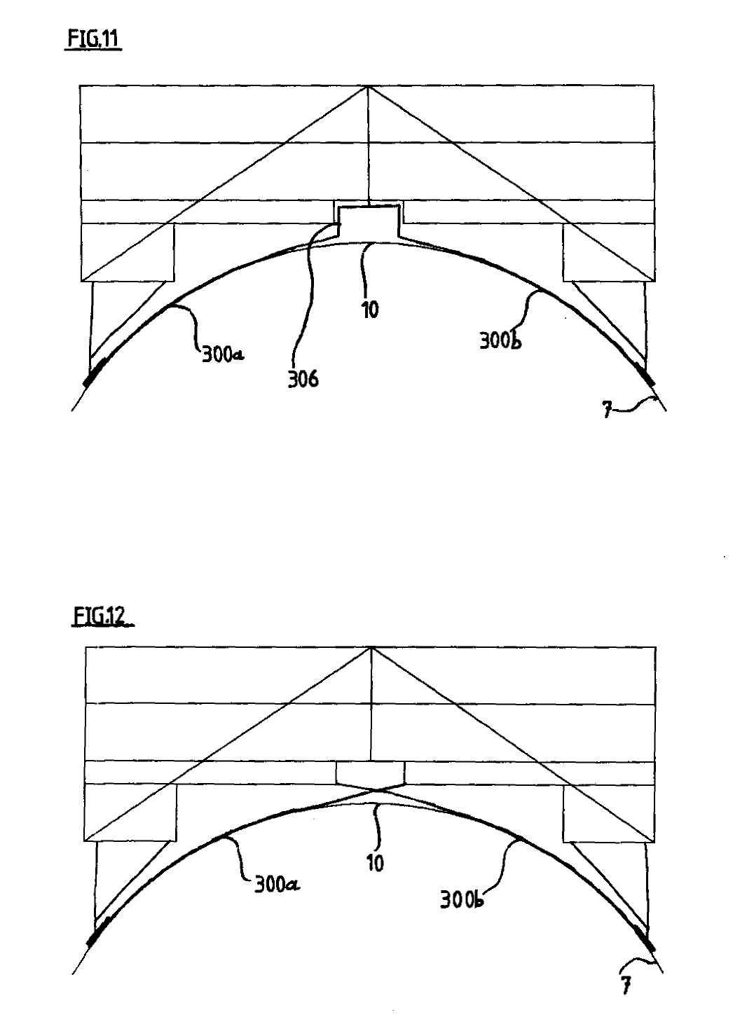

FIG. 10 shows an alternative embodiment of the strap according to the invention,

FIG. 11 shows a strap divided in two with retaining clips,

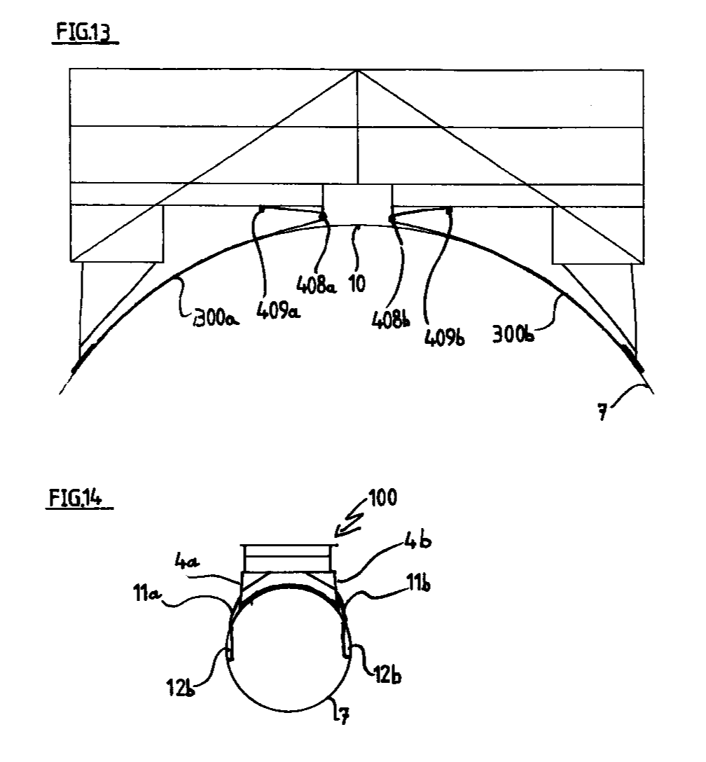

FIG. 12 shows a crossover fastening of the straps according to the invention,

FIG. 13 shows a deflection of the straps according to the invention at the upper articulation point,

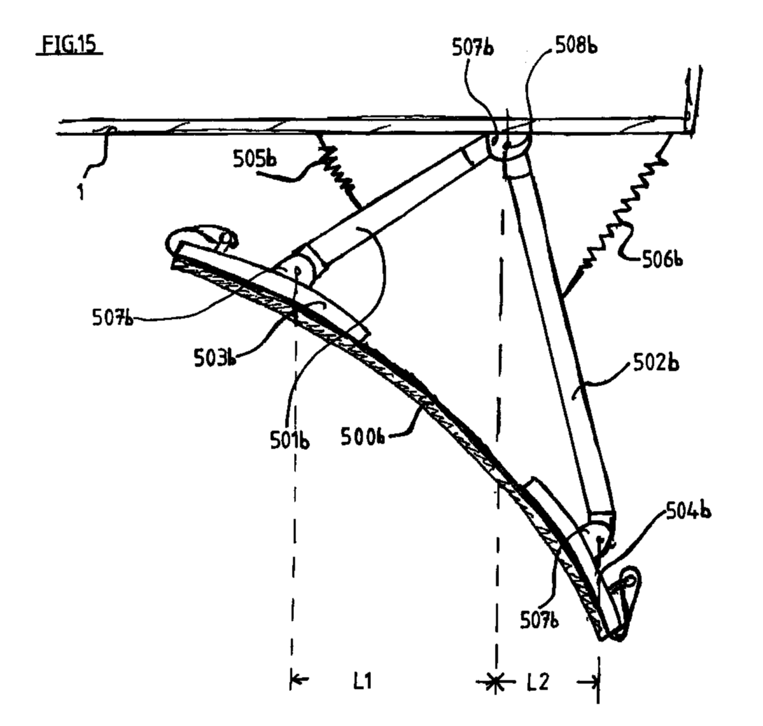

FIG. 14 schematically shows securing of the saddle platform against slipping,

FIG. 15 shows alternative fastening of a strap divided in two, each with a pair of supports which are fastened by pressure distribution panels to the ends of a respective strap part.

FIG. 1 shows a schematic, three-dimensional view of the saddle platform according to the invention. The saddle platform comprises a supporting structure 1, a working level which comprises a plurality of elements 2a to 2f and bearing surfaces in the form of straps 3. A fundamental element of the saddle platform is the straps 3 bent approximately in the manner of a divided circle and with which the saddle platform is placed on the upper face of the fuselage. In the embodiment shown in FIG. 1 the straps 3 are constructed as bent metal strips that are additionally padded on their lower side with the aid of a microcellular layer or some other padding. The metal strips 3 are pre-bent according to the curvature of the fuselage with a slightly larger radius of curvature but owing to the flexibility of the sheet metal can adapt to the fuselage and any irregularities in the surface thereof.

FIG. 3 shows mounting of the straps 3a, 3b on an air cushion as alternative to padding using microcellular rubber. For this purpose compressed air is blown through ducts let into the straps onto the lower side of the straps, i.e. between the strap and the upper face of the fuselage 7.

The straps 3 are connected with the aid of supports 4a, 4b of the supporting structure to the elements of the supporting structure arranged above the straps 3. The supports 4a, 4b can be rigid supports, as shown in FIG. 1, or can be adjustable, so the saddle platform can be adapted to different aircraft designs.

The supports 4a, 4b are reproduced only schematically here and can moreover comprise cross-members and/or resilient elements. In any case it must be ensured that the supports do not introduce point loads into the surface of the fuselage. This is primarily ensured by the limited extensibility of the straps which adapt to the fuselage when placed thereon but are increasingly tensioned in the process, so these supported ends of the straps touch the fuselage only lightly and in any case not with any greater load per surface area than the relatively large sections of strap located therebetween.

FIG. 2 schematically shows correspondingly designed supports, it being possible to adapt the height of the supports 40a, 40b using hydraulic drives.

The saddle platform shown in FIG. 1 has a working level comprising a total of six elements 2a to 2f. These are each arranged in opposing pairs, a spacing, remaining between the individual levels, for example 2d and 2e, in which the surface of the fuselage is accessible. The elements 2a, 2f and 2c, 2d are located above the apex of the fuselage. These elements of the working level can be used as auxiliary levels, for example for putting down tools. The spacings between these elements 2a, 2f and 2c, 2d can be bridged using fold-down elements 5a to 5d of the working level if there are no parts, for example antennae, for maintaining arranged below these elements. By contrast the elements 2b, 2e of the working plane are located at the level of the fuselage apex or slightly therebelow. Together with the upper face of the fuselage this results in a continuous, almost level surface. The antennae arranged in this region of the fuselage, in particular the parabolic antenna for receiving broadband communication signals, can thus be conveniently maintained. To prevent tools or individual components from failing the edges 6 of the elements 2b, 2e of the working level are configured with a rubber lip as a sealing element. The rubber lip ends flush with the upper face of the aircraft fuselage, so tools or components which slide down on the curved upper face of the fuselage slide only as far as the edge 6 of the working level 2b, 2e. Alternatively or additionally this region may also be masked with conventional tape.

In the embodiment shown in FIG. 1 eight respective straps 3 are arranged side by side at a spacing from each other in the longitudinal direction of the aircraft, whereas in the circumferential direction two respective straps 3 are symmetrically arranged with respect to the apex of the fuselage. The spacing of the straps 3 in the longitudinal direction is chosen such that it substantially matches the frame spacing of the fuselage. Variations in the frame spacing can be absorbed owing to the width of the individual straps 3, each strap still coming to rest over a frame.

The spacing between the straps in the longitudinal direction of the fuselage is 530 mm, measured between the center points of two adjacent straps. This dimension is identical to the spacing of the frames or stringers of an airbus A 340.

In the illustrated embodiment the supporting structure is made from aluminum, for example using the post-joint technique or framework construction, to keep the weight of the saddle platform as low as possible. Other lightweight constructions, for example made of carbon fiber-reinforced plastics material, are also possible as an alternative however.

In the preferred variant the saddle platform shown in FIG. 1 has outer dimensions of 5×8 m. These dimensions are sufficient for maintaining the new broadband communication antennae, of which the aerodynamic covering has dimensions of about 2.2×1.2 m.

As a result of the dimensions of the straps 3 shown in FIG. 1 and the limited extensibility associated therewith, these embodiments are particularly suitable for use on aircraft with approximately the same fuselage curvatures since the pre-curved metal straps have only a small margin of curvature adjustment.

By contrast the embodiments of the straps shown in FIGS. 4 and 5 are better suited in particular for placement of the saddle platform on different aircraft designs with different fuselage widths and fuselage surface curvatures.

The embodiment shown in FIG. 4 comprises symmetrically arranged bearing elements 31a, 31b each with four straps 3a to 3d. The individual straps 3a to 3d are elements made of sheet aluminum which constitute sections of the straps 3 shown in FIG. 1 but which can also assume the shape of round plates. These are joined using hinges 32 and connecting elements 33 to give a flexible harness, so the individual elements can adapt to the radius of any aircraft design.

The embodiment of the invention shown in FIG. 5 comprises a strap 300 which is made of a textile material. It flexibly adapts to the surface of the fuselage 7. The illustrated strap runs continuously from a first fastening on the left-hand support 400a, across the apex of the fuselage 7 to a second fastening on the right-hand support 400b. The fastenings of the strap are attached to the supports 400a, 400b so as to be articulated in order to ensure optimum adaptation to the surface of the fuselage even in the region of the suspension. The supports 400a, b; 401a, b are adjustable, preferably in their longitudinal direction, in order to be able to optimally adjust the tension of the strap such that there is no elevated loading of the fuselage underneath the supports.

FIG. 6 shows the construction of the strap 300 in detail. An approximately 2 mm thick textile strap 301 which is made from woven material of the type made to brace and lift heavy loads using a crane, serves to disperse the forces. On its underside the textile material 301 is coated with a foamed material layer 2 which protects the fuselage against potential damage from the strap or from contaminants between strap and fuselage. To avoid abrasion of the foamed material 302 even with pronounced stressing of the strap 300, the foamed material is coated on its underside, i.e. on the bearing surface, with a protective later 303 of silicone or similar covering material.

The textile strap 300 shown in FIGS. 5 and 6 readily adapts to the curvature of most aircraft designs. However, rigid supports 400a, 400b of the embodiment in FIG. 5 would lead to the spacing of the working level 5 from the apex 10 of the fuselage 7 being dependent on the diameter of the fuselage 7 of the respective design.

Height-adjustable supports are necessary to keep the working level 5 at the same height in relation to the apex 10 of the fuselage 7 even with different aircraft designs and to avoid the introduction of point forces into the fuselage. One possibility for such height-adjustable supports has already been illustrated in FIG. 2 in connection with straps made from metal or sheet metal. The hydraulic supports 40a, 40b shown here can however also be used with textile straps.

FIG. 7 shows an alternative embodiment for a height-adjustable or adaptable support. The illustrated supports 400′a and 400′b can be varied in height and in effective support spacing using bending elements.

FIGS. 8A and 8B show a preferred, alternative embodiment of the height-adjustable supports. The left support 400″a is shown respectively. It has a low position shown in FIG. 8A and a high position shown in FIG. 8B. The support comprises a tensile element 401″a and a length-adjustable supporting element 402″a. Using hinges 403″a the elements 401″a, 402″a are joined to the element 404″a of the supporting structure located thereabove and to each other in such a way that the parts 401″a, 402″a and 404″a form a triangular structure. The supporting element 402″a is adjusted in height by the division in two of the supporting element and two telescopic cylindrical sections. The two displaceable elements are secured with respect to each other using a quick release pin 405″a. Joining of the height-adjustable supporting element 402″a and the tensile element 401″a means that the height of the element 402″a is changed, as is the angle thereof in relation to the element 404″a of the supporting structure located thereabove. To be able to optionally adjust this angle again, suspension 406″a of the element 401″a on the supporting element 402″a may also be varied in height. To compensate for possible differences in the length of the straps a resilient element 410″a is moreover provided at the lower end of the supporting element.

As an alternative to the illustrated embodiment in which the element 402″a is adjusted in height using two telescopic cylindrical elements, a threaded height adjustment may also be provided between the elements.

The embodiment shown in FIG. 5 with a continuous strap 300. i.e. reaching over the apex 10 of the fuselage 7, can prove to be impractical in certain situations if antennae or other devices are arranged on the fuselage at the apex 10 thereof and in the region of the frames. In this ease the embodiments shown in FIGS. 9 to 14 are advantageous.

The strap shown in FIG. 9 is divided in two with elements 300a, 300b, the elements being joined together in the region of the apex 10 of the fuselage using two connecting straps 304. A recess 305 for receiving the antennae arranged on the fuselage is provided between the connecting straps 304. This arrangement can be seen particularly clearly in the plan view of FIG. 9A.

FIG. 10 likewise shows a two-piece embodiment of the strap 300 with elements 300a, 300b. Each of the straps 300a, 300b is joined to one of the supports 400a, 400b and to a further support 407a, 407b in the region upstream of the apex 10 of the fuselage 7. The apex 10 of the fuselage is not covered by either of the straps 300a, 300b therefore. Suspension can be directly from the supports 407a, 407b or by way of a crossbeam in this case.

FIG. 11 shows a further alternative embodiment of the invention. The two strap elements 300a, 300b that are separate from each other are joined together in the region of the apex 10 of the fuselage 7 by a retaining clip 306 made of steel, the retaining clip 306 reaching around possible objects on the upper face of the fuselage and allowing load dispersal between the two straps 300a, 300b.

FIG. 12 shows crossover bracing of the straps 300a, 300b, whereby increased spacing is attained between the strap 300a, 300b and the fuselage 7 in the region of the apex 10 thereof. Crossover bracing of this kind requires the straps to be slit in the region of the apex, so they can reach through each other.

In the embodiment shown in FIG. 13 the straps 300a and 300b are articulated to the fastening structure by deflection pulleys 408a and 408b. The position of the fastening points 409a and 409b can be adjusted, so differences in the lengths of the belts 300a, 300b can be compensated.

FIG. 14 schematically shows securing of the saddle platform 100 against slipping. From the supports 4a, 4b of the platform securing straps 11a, 11b are connected to the upper edges of the left-hand and right-hand doors 12a, 12b.

It is understood that a plurality of strap variations shown in FIGS. 5 to 7 and 9 to 13 can be implemented on one and the same saddle platform. In particular continuous straps according to FIGS. 5 to 7, 9 and 12 can be provided at axial positions at which the apex of the fuselage does not need to be accessible, while the variations in FIGS. 10, 11 and 13 are used in particular at the axial positions of the fuselage at which the apex does need to be accessed.

FIG. 15 shows an alternative fastening of the strap according to the invention which, specifically, consists of two strap sections. Strap section 500b is fixed between two pressure distribution panels 503b, 504b. The panels 503b, 504b are each connected to a support 501b, 502b so as to be articulated. The two supports are in turn pivotally suspended in a common pivot point 508b.

With a suitably selected spacing between the pivot points of the right-hand supports 501b, 502b and the left-hand supports (not shown) and corresponding lengths of the supports 501b, 502b and strap section 500b, the supports, when the platform is placed on the fuselage, swivel on the fuselage in such a way that the projections L1, L2 of the supports in a horizontal plane have the same length. Optimum load dispersal is thus achieved along the strap without an elevated point load occurring in the region of the pressure distribution panels 503b, 504b.

To keep the strap section 500b tensioned even if the saddle platform is not placed on a fuselage, the two supports 501b, 502b are pre-tensioned against the supporting structure, and therefore away from each other, using resilient elements 505b, 506b.

For the purpose of original disclosure reference is made to the fact that all features, as are revealed to a person skilled in the art from this description, the drawings and the claims, even if they have only been specifically described in connection with certain additional features, can be combined both individually and in any desired groupings with other features or groups of features disclosed here, provided this has not been explicitly ruled out or technical conditions make such a combination impossible. The comprehensive, explicit illustration of all conceivable combinations of features will be omitted here purely for the sake of brevity and readability of the description.

### LIST OF REFERENCE NUMERALS

1 supporting structure
2a to 2f elements
3 strap, metal strip
3a to 3d straps
4a, 4b supports
5 working level
6 edges
7 fuselage
10 apex
11a, 11b securing strap
12a, 12b upper edges of the left and right doors
31a, 31b bearing elements
32 hinges
33 connecting elements
40a, 40b supports
100 saddle platform
300 strap
300a, 300b elements of the strap
301 textile strap
302 foamed material layer
303 protective layer
304 connecting strap
305 recess
306 retaining clip
400a left-hand support
400b right-hand support
400′a, 400′b supports
400″a support
401″a tensile element
402″a supporting element
403″a hinges
404″a element of the supporting structure
405″a quick release pin
406″a suspension
407a, 407b supports
408a, 408b deflection pulleys
409a, 409b fastening points
410″a resilient element
500b strap
501b support
502b support
503b pressure distribution panel
504b pressure distribution panel
505b resilient element
506b resilient element
507b hinge
508b pivot point

1. A saddle platform for an aircraft, comprising a working level, a supporting structure and at least one bearing surface which is constructed as a strap wherein the strap substantially extends in the circumferential direction of the fuselage along a substantially circular or elliptical fuselage cross-section.

2. The saddle platform as claimed in claim 1, wherein the strap is made from a sheet metal, preferably aluminum.

3. The saddle platform as claimed in 1 or 2, wherein the strap is made from a textile material.

4. The saddle platform as claimed in claim 1 to 2, wherein a plurality of, preferably 2, 4, 6 or 8, straps are arranged so as to extend in the circumferential direction and side by side in the axial direction of the fuselage.

5. The saddle platform as claimed in any one of claims 1 to 2, wherein the strap has a width of about 100 mm to 600 mm, preferably a width of 200 mm to 400 mm.

6. The saddle platform as claimed in any one of claims 1 to 2, wherein the straps have a spacing which matches the spacing of the frames of the fuselage or an integral multiple thereof.

7. The saddle platform as claimed in any one of claims 1 to 2, wherein the straps have a spacing between 500 mm and 530 mm, in particular of about 530 mm or about 20 inches (508 mm).

8. The saddle platform as claimed in any one of claims 1 to 7 wherein the length of the strap in the circumferential direction is at least 200 mm, preferably at least 500 mm.

9. The saddle platform as claimed in any one of claims 1 to 2, wherein the straps extend over approximately one quarter, and preferably over approximately one third, of the circumference of the fuselage.

10. The saddle platform as claimed in any one of claims 1 to 2, wherein a plurality of, preferably 2, 4, 6 or 8, straps are arranged one behind the other in the circumferential direction of the aircraft.

11. The saddle platform as claimed in any one of claims 1 to 2, wherein at least some of the straps are arranged in such a way that the apex region of the fuselage is not covered by the straps.

12. The saddle platform as claimed in any one of claims 1 to 2, wherein the strap has padding, preferably consisting of foamed material, microcellular rubber or air.

13. The saddle platform as claimed in any one of claims 1 to 2, wherein the geometry of the strap and/or the supporting structure can be adjusted for different aircraft widths or fuselage diameters.

14. The saddle platform as claimed in any one of claims 1 to 2, wherein it comprises a mechanism to secure against slipping.

15. The saddle platform as claimed in claim 14, wherein the securing mechanism is a strap which reaches around the fuselage or through it.

16. The saddle platform as claimed in claim 14, wherein the securing mechanism is a strap which is hooked by one end in the frame of a door opening.

17. The saddle platform as claimed in claim 14, wherein the securing mechanism can be connected to the fuselage or a part secured thereto.

18. The saddle platform as claimed in claim 14, wherein the securing mechanism is a support against the bearing surface.

19. The saddle platform as claimed in any one of claims 1 to 2, wherein the working level comprises a plurality of elements.

20. The saddle platform as claimed in claim 19, wherein the elements can be displaced relative to each other.

21. The saddle platform as claimed in claim 19, wherein the elements extend as far as the fuselage.

22. The saddle platform as claimed in claim 19, wherein at their edges the elements comprise sealing elements which allow flush finishing with the fuselage.

23. The saddle platform as claimed in any one of claims 1 to 2, wherein the strap is connected to two pivotally fastened supports.

24. The saddle platform as claimed in claim 23, wherein the supports can be pivoted about the same pivot point.

25. The saddle platform as claimed in claim 23, wherein the supports are pre-tensioned against the supporting structure by springs, the strap also being tensioned if the platform is not placed on a fuselage.

26. The saddle platform as claimed in claim 23, wherein the projections of the supports in a horizontal plane are of equal length if the platform is placed on a fuselage.

27. The saddle platform as claimed in any one of claims 1 to 2, wherein the strap is connected to a pressure distribution panel that is preferably fastened so as to be articulated.

28. The saddle platform as claimed in any one of claims 1 to 2, wherein the saddle platform comprises devices, for example rollers or chains, so it can be displaced toward the fuselage.

29. The saddle platform as claimed in any one of claims 1 to 2, wherein it may be dismantled.

30. The saddle platform as claimed in any one of claims 1 to 2, wherein the individual elements can be secured relative to each other using quick release pins.
